(19) United States
(12) Patent Application Publication
(10) Pub. No.: US 2026/0058077 A1
(43) Pub. Date: Feb. 26, 2026

(54) COMPOSITE FUNCTION KEYBOARD CIRCUIT

(71) Applicant: Primax Electronics Ltd., Taipei (TW)

(72) Inventors: Yi-Liang Chen, Taipei (TW); Chih-Chen Chang, Taipei (TW); Yu-Ting Lo, Taipei (TW)

(21) Appl. No.: 18/925,463

(22) Filed: Oct. 24, 2024

(30) Foreign Application Priority Data
Aug. 21, 2024 (CN) 202411151134.3

(51) Int. Cl. H01H 13/70; G06F 3/02

(52) U.S. Cl. CPC H01H 13/70; G06F 3/0202

(57) ABSTRACT

A composite function keyboard circuit includes a matrix circuit, a bias resistor circuit and a controller. Each switch unit in the matrix circuit includes an ink-type force sensing switch and an anti-ghosting unit. A pressure-related resistance of the ink-type force sensing switch is variable according to a pressing mode of a keypress action. An electrical connection path is defined by the ink-type force sensing switch and the corresponding bias resistor of the bias resistor circuit. When the ink-type force sensing switch is electrically conducted, a divided conduction voltage is generated by the electrical connection path. According to a level of the divided conduction voltage, the controller generates a corresponding key control instruction, and the controller judges whether the switch unit in the switch unit group is effectively turned on. Consequently, a ghost key phenomenon is avoided.

### FIELD OF THE INVENTION

The present invention relates to an input device keyboard circuit, and more particularly to a keyboard circuit for operating a single key to execute various types of key function instructions while avoiding the ghost key phenomenon.

### BACKGROUND OF THE INVENTION

Conventionally, a keyboard device includes a keyboard circuit. When a single key of the keyboard device is pressed down, the keyboard circuit is triggered to generate a key signal. Furthermore, when a set of keys are pressed down simultaneously, a specified result is generated. The set of keys are also referred as a combination key or a composite key. For example, when the “Shift” key and the “A” key are pressed down simultaneously by the user, a controller of the keyboard circuit issues a composite key code corresponding to the depressed keys. The composite key code represents a key control instruction for executing a specified control function (e.g., an “acceleration” function).

However, the method of simultaneously pressing down two keys or a combination key (or a composite key) to execute a specified control function is not suitable for the applications requiring the fast operation speed (e.g., the applications on electronic sports). For example, the action of simultaneously pressing down two keys or a composite key to execute a specified control function increases the operating time or increases the probability of pressing errors. Therefore, it is important to provide a method or a mechanism of executing various types of key function instructions by triggering a single key.

Nowadays, some solutions have been proposed in the market. For example, a single key is operated to execute various types of key function instructions according to the continuous change characteristics of a capacitive sensing technology or an optical sensing technology. However, the cost of implementing the above solution is high, or the method of implementing the above solution is very difficult. In addition, since the keyboard device using these technologies is very complicated, it is difficult to reduce the overall volume of the assembled structure of the keyboard device.

On the other hand, the keyboard circuit is further equipped with a mechanism for preventing from the ghost key phenomenon when any key is operated.

In order to overcome the drawbacks of the conventional technologies, it is important to provide an improved keyboard circuit for operating a single key to execute various types of key function instructions in a cost-effective and reliable manner while avoiding the ghost key phenomenon.

### SUMMARY OF THE INVENTION

In order to overcome the drawbacks of the conventional technologies, the present invention provides a composite function keyboard circuit for operating a single key to execute various types of key function instructions while avoiding the ghost key phenomenon.

In accordance with an aspect of the present invention, a composite function keyboard circuit is provided. The composite function keyboard circuit includes a matrix circuit, a bias resistor circuit and a controller. The matrix circuit includes a driving line group with a plurality of driving lines, a sensing line group with a plurality of sensing lines and a switch unit group with a plurality of switch units. The plurality of driving lines and the plurality of sensing lines are arranged in a matrix. Each of the switch units of the switch unit group is electrically connected with the corresponding sensing line and the corresponding sensing line. The bias resistor circuit is electrically connected with the sensing line group and serially connected with the switch unit group. The bias resistor circuit includes a plurality of bias resistors. A first terminal of each bias resistor of the bias resistor circuit is electrically connected with the sensing line group and the switch unit group. A second terminal of each bias resistor of the bias resistor circuit is connected with a ground terminal. The controller is electrically connected with the driving line group, the sensing line group and the first terminal of each of the bias resistors of the bias resistor circuit. Each of the switch units in the switch unit group includes an ink-type force sensing switch and an anti-ghosting unit. A pressure-related resistance of the ink-type force sensing switch is variable according to a pressing mode of a keypress action. An electrical connection path is defined by the ink-type force sensing switch and the corresponding bias resistor of the bias resistor circuit. When the ink-type force sensing switch is electrically conducted, a divided conduction voltage is generated by the electrical connection path. According to a level of the divided conduction voltage, the controller generates a corresponding key control instruction, and the controller judges whether the switch unit in the switch unit group is effectively turned on. Consequently, a ghost key phenomenon is avoided.

In an embodiment, a series electrical structure is defined by a first terminal of the ink-type force sensing switch and a first terminal of the anti-ghosting unit. Each driving line in the driving line group is electrically connected with one of a second terminal of the ink-type force sensing switch and a second terminal of the anti-ghosting unit in series. Each sensing line in the sensing line group is electrically connected with the other of the second terminal of the ink-type force sensing switch and the second terminal of the anti-ghosting unit in series.

In an embodiment, the anti-ghosting unit is a high-resistance element, and a resistance of the high-resistance element and a resistance of the corresponding bias resistor in the electrical connection path are equal or nearly equal.

In an embodiment, the high-resistance element is a high-resistance carbon equivalent resistor that is formed by using a carbon paste printing process.

In an embodiment, the pressure-related resistance of the ink-type force sensing switch in response to the keypress action is in a specified percentage range of the resistance of the high-resistance element.

In an embodiment, a highest value of the pressure-related resistance of the ink-type force sensing switch in response to the keypress action is in a range between 20% and 40% of the resistance of the high-resistance element.

In an embodiment, a lowest value of the pressure-related resistance of the ink-type force sensing switch in response to the keypress action is in a range between 0% and 6% of the resistance of the high-resistance element.

In an embodiment, the anti-ghosting unit is a diode, and a ratio of the pressure-related resistance of the ink-type force sensing switch in response to the keypress action to the resistance of the corresponding bias resistor in the electrical connection path is in a specified ratio range.

In an embodiment, the ratio of the pressure-related resistance to the resistance of the corresponding bias resistor in the electrical connection path is in a range between 0.6 and 1.6.

In an embodiment, as a force exerted on the ink-type force sensing switch in response to the keypress action is increased, the pressure-related resistance of the ink-type force sensing switch is decreased.

In an embodiment, if the pressure-related resistance is higher than a resistance threshold value, the ink-type force sensing switch is in a light pressing mode, and the controller generates a first key control instruction. If the pressure-related resistance is lower than or equal to the resistance threshold value, the ink-type force sensing switch is in a heavy pressing mode, and the controller generates a second control instruction.

In an embodiment, the resistance threshold value is set by a user through an application software.

In an embodiment, the ink-type force sensing switch at least includes a top printed conductive film, a bottom printed conductive film and an elastic separation layer. The elastic separation layer is arranged between the top printed conductive film and the bottom printed conductive film.

In an embodiment, the top printed conductive film at least includes a top substrate, an upper conductive sliver paste layer and an upper carbonaceous conductive ink layer, and the bottom printed conductive film at least includes a lower carbonaceous ink layer, a lower conductive silver paste layer and a bottom substrate. An adhesive layer is arranged between the top substrate and the bottom substrate.

In an embodiment, each of the top substrate and the bottom substrate is made of polyethylene terephthalate (PET), or the elastic separation layer is made of UV-curable adhesive.

Furthermore, at a first time point, the controller provides a working voltage to a first one of the plurality of driving lines in the driving line group, and the divided conduction voltages from the switch units connected with the first one of the plurality of driving lines are transmitted through the sensing line group. At a second time point, the controller provides the working voltage to a second one of the plurality of driving lines in the driving line group, and the divided voltages from the switch units connected with the second one of the plurality of driving lines are transmitted through the sensing line group.

In an embodiment, if the divided conduction voltage corresponding to a specified switch unit of the plurality of switch units lies in a first voltage range, the controller judges that the specified switch unit is normally turned on. If the divided conduction voltage corresponding to the specified switch unit lies in a second voltage range, the controller judges that the specified switch unit is not normally turned on.

In an embodiment, the working voltage is Vin, and the first voltage range is from 0.228×Vi to 0.5×Vin.

In an embodiment, the working voltage is Vin, and the second voltage range is 0.06×Vin to 0.226×Vin.

In an embodiment, the working voltage is 5V.

In an embodiment, the first voltage range is from 1.14V to 2.5V.

In an embodiment, the second voltage range is 0.32V to 1.13V.

In an embodiment, the controller includes a multiplexer, an analog-to-digital converter and a processor. The multiplexer is electrically connected with the sensing line group and the first terminal of each of the plurality of bias resistors in the bias resistor circuit. The analog-to-digital is electrically connected with the multiplexer. The processor is electrically connected with the multiplexer, the analog-to-digital converter and the driving line group.

In an embodiment, the controller at least includes a voltage divider, a transition circuit and a processor, wherein the voltage divider is electrically connected to with the sensing line group and the first terminal of each of the plurality of bias resistors in the bias resistor circuit, the transition circuit is electrically connected with the voltage divider, and the processor is electrically connected with the transition circuit and the driving line group, wherein the transition circuit at least includes a transistor.

In an embodiment, the controller at least includes a comparator, a comparison reference source and a processor. The comparator is electrically connected with the sensing line group and the first terminal of each of the plurality of bias resistors in the bias resistor circuit. The comparison reference source is electrically connected with the comparator. The processor is electrically connected with the comparator and the driving line group.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit diagram illustrating a composite function keyboard circuit according to a first embodiment of the present invention;

FIG. 2A schematically illustrates different operation modes of a switch unit of the second switch unit group in the composite function keyboard circuit as shown in FIG. 1;

FIG. 2B is a schematic cross-sectional view illustrating a switch unit of the switch unit group in the composite function keyboard circuit as shown in FIG. 1;

FIG. 3 schematically illustrates a process of defining the resistance threshold value of an ink-type force sensing switch in the switch unit of the composite function keyboard circuit as shown in FIG. 1 through an operation interface of an adjustment program;

FIG. 4 is a schematic circuit diagram illustrating a composite function keyboard circuit of FIG. 1 according to a second embodiment of the present invention;

FIG. 5 is a schematic functional block diagram illustrating a variant example of the controller used in the composite function keyboard circuit according to the first embodiment of the present invention; and

FIG. 6 is a schematic functional block diagram illustrating a variant example of the controller used in the composite function keyboard circuit of FIG. 4 according to the second embodiment of the present invention.

### DETAILED DESCRIPTION OF THE PREFERRED EMBODIMENT

The present invention will now be described more specifically with reference to the following embodiments and accompanying drawings.

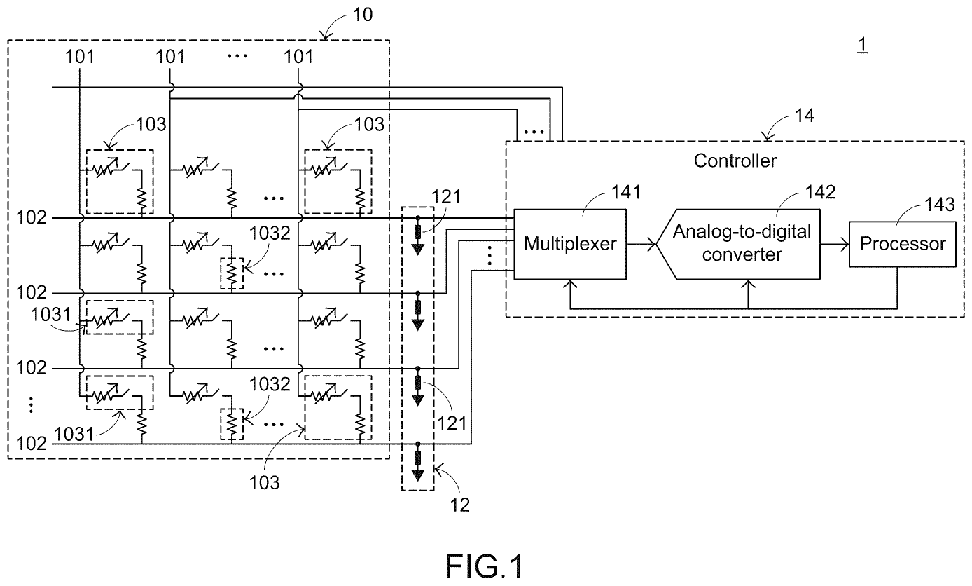

FIG. 1 is a schematic circuit diagram illustrating a composite function keyboard circuit according to a first embodiment of the present invention. As shown in FIG. 1, the composite function keyboard circuit 1 at least includes a matrix circuit 10, a bias resistor circuit 12 and a controller 14.

The matrix circuit 10 includes a driving line group with a plurality of driving lines 101, a sensing line group with a plurality of sensing lines 102 and a switch unit group with a plurality of switch units 103. The plurality of driving lines 101 are arranged along a vertical direction. The plurality of sensing lines 102 are arranged along a horizontal direction. The plurality of driving lines 101 and the plurality of sensing lines 102 are arranged in a matrix. Each of the switch units 103 is electrically connected with the corresponding driving line of the plurality of driving lines 101 and the corresponding sensing line of the plurality of sensing lines 102.

The bias resistor circuit 12 is electrically connected with the sensing lines 101. In addition, the bias resistor circuit 12 is connected with the switch units 103 in series. The bias resistor circuit 12 includes a plurality of bias resistors 121. A first terminal of each bias resistor 121 of the bias resistor circuit 12 is electrically connected with the corresponding sensing line 102 and the corresponding switch unit 103. In addition, a second terminal of each bias resistor 121 of the bias resistor circuit 12 is connected with a ground terminal.

In this embodiment, the controller 14 includes a multiplexer 141, an analog-to-digital converter 142 and a processor 143.

Due to cooperation of the matrix circuit 10 and the bias resistor circuit 12, the operation of any single key can execute various types of key function instructions. In addition, the operation of any single key can well achieve the ghost key preventing function in a cost-effective manner. The operating principles will be described in more details later.

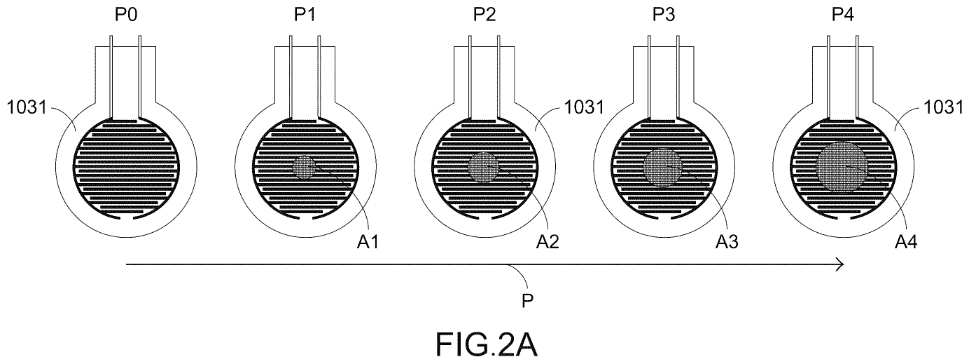

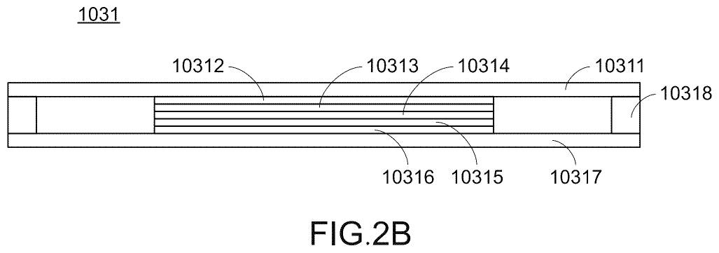

In accordance with a feature of the present invention, each of the switch units 103 includes an ink-type force sensing switch (FSR) 1031 and an anti-ghosting unit 1032. The pressure-related resistance of the ink-type force sensing switch 1031 is variable in response to a keypress action P in a corresponding pressing mode. The keypress action P will be described in more details later in FIG. 2A. In addition, an electrical connection path is defined by the ink-type force sensing switch 1031 and the corresponding bias resistor 121 of the bias resistor circuit 12. When the ink-type force sensing switch 1031 is electrically conducted or turned on, a divided conduction voltage (e.g., the voltage at the first terminal of the corresponding bias resistor 121 of the bias resistor circuit 12) is generated by the electrical connection path. According to the level of the divided conduction voltage, the controller 14 generates a corresponding key control instruction. The type of the key control instruction may be determined according to the practical requirements. For example, the key control instruction includes a single key control instruction or a composite key control instruction. Alternatively, the big data of different key operations (e.g., keypress operations) used as the input data for AI training and analysis models can be correspondingly generated. According to the divided conduction voltage, the controller 14 judges whether any switch unit 103 is effectively pressed down and turned on. Consequently, a ghost key preventing function can be achieved.

A series electrical structure is defined by a first terminal of the ink-type force sensing switch 1031 and a first terminal of the anti-ghosting unit 1032. Each driving line 101 in the driving line group is electrically connected with one of a second terminal of the ink-type force sensing switch 1031 and a second terminal of the anti-ghosting unit 1032 in series. Each sensing line 102 in the sensing line group is electrically connected with the other of the second terminal of the ink-type force sensing switch 1031 and the second terminal of the anti-ghosting unit 1032 in series.

In the embodiment of FIG. 1, the anti-ghosting unit 1032 is a high-resistance element. Furthermore, the resistance of the anti-ghosting unit 1032 and the resistance of the corresponding bias resistor 121 in the electrical connection path are equal or nearly equal.

Preferably but not exclusively, the high-resistance element is a high-resistance carbon equivalent resistor that is formed by using a carbon paste printing process.

In response to the keypress action P shown in FIG. 2A, a corresponding pressure-related resistance is generated. According to settings, the pressure-related resistance is in a specified percentage range of the resistance of the high-resistance element.

In an embodiment, the highest pressure-related resistance of the ink-type force sensing switch 1031 in response to the keypress action P is set to be in the range between 20% and 40% of the resistance of the high-resistance element, and the lowest pressure-related resistance of the ink-type force sensing switch 1031 in response to the keypress action P is set to be in the range between 0% and 6% of the resistance of the high-resistance element.

For example, the resistance of the high-resistance carbon equivalent resistor is 5 k ohms. Under this circumstance, the highest pressure-related resistance of the ink-type force sensing switch 1031 in response to the keypress action P is set to be in the range between 1 k ohms and 2 k ohms (i.e., approximately 20% and 40% of the resistance of the high-resistance carbon equivalent resistor). Consequently, the user can operate a single key to execute various types of key function instructions. Although the highest pressure-related resistance (i.e., in the range between 1 k ohms and 2 k ohms) is additionally generated by the ink-type force sensing switch 1031, the voltage level of the divided conduction voltage generated in the electrical connection path of the ink-type force sensing switch 1031, the anti-ghosting unit 1032 (i.e., the high-resistance element) and the corresponding bias resistor 121 of the bias resistor circuit 12 is still subjected to the change. In other words, the function of operating a single key to execute various types of key function instructions and the function of avoiding the ghost key phenomenon can be both achieved.

Similarly, it is assumed that the resistance of the high-resistance carbon equivalent resistor is 5 k ohms. Under this circumstance, the lowest pressure-related resistance of the ink-type force sensing switch 1031 in response to the keypress action P is set to be in the range between 0 ohm and 300 ohms (i.e., approximately 0% and 6% of the resistance of the high-resistance carbon equivalent resistor). The lowest pressure-related resistance (i.e., in the range between 0 ohm and 300 ohms) additionally generated by the ink-type force sensing switch 1031 is very low. Consequently, the voltage level of the divided conduction voltage generated in the electrical connection path of the ink-type force sensing switch 1031, the anti-ghosting unit 1032 (i.e., the high-resistance element) and the corresponding bias resistor 121 of the bias resistor circuit 12 can be surely subjected to the change. In other words, the operation of any single key can prevent from the ghost key phenomenon.

FIG. 2A schematically illustrates different operation modes of a switch unit of the second switch unit group in the composite function keyboard circuit as shown in FIG. 1. For example, the switch unit 1031 is an ink-type force sensing switch.

As shown in FIG. 2A, a keypress action P is performed on one key in response to a downward force. In the drawings of FIG. 2A, the magnitude of the downward force is gradually increased from left to right.

The ink-type force sensing switch 1031 includes a top printed conductive film and a bottom printed conductive film, which will be described later in FIG. 2B. In an initial mode P0 of the ink-type force sensing switch 1031, the top printed conductive film and the bottom printed conductive film of the ink-type force sensing switch 1031 are not contacted with each other. That is, the ink-type force sensing switch 1031 is in an open-circuited state. Since there is no electrical contact area between the top printed conductive film and the bottom printed conductive film of the ink-type force sensing switch 1031, the pressure-related resistance of the ink-type force sensing switch 1031 is the highest.

As the magnitude of the downward force in response to the keypress action P is increased, the ink-type force sensing switch 1031 is in a first pressing mode P1. Since there is a first electrical contact area A1 between the top printed conductive film and the bottom printed conductive film of the ink-type force sensing switch 1031, the pressure-related resistance of the ink-type force sensing switch 1031 is decreased.

Similarly, as the magnitude of the downward force in response to the keypress action P is further increased, the ink-type force sensing switch 1031 is in a second pressing mode P2. Since there is a second electrical contact area A2 between the top printed conductive film and the bottom printed conductive film of the ink-type force sensing switch 1031, the pressure-related resistance of the ink-type force sensing switch 1031 is further decreased.

Similarly, as the magnitude of the downward force in response to the keypress action P is further increased, the ink-type force sensing switch 1031 is in a third pressing mode P3. Since there is a third electrical contact area A3 between the top printed conductive film and the bottom printed conductive film of the ink-type force sensing switch 1031, the pressure-related resistance of the ink-type force sensing switch 1031 is further decreased.

Similarly, as the magnitude of the downward force in response to the keypress action P is further increased, the ink-type force sensing switch 1031 is in a fourth pressing mode P4. Since there is a fourth electrical contact area A4 between the top printed conductive film and the bottom printed conductive film of the ink-type force sensing switch 1031, the pressure-related resistance of the ink-type force sensing switch 1031 is further decreased.

FIG. 2B is a schematic cross-sectional view illustrating a switch unit of the switch unit group in the composite function keyboard circuit as shown in FIG. 1. In FIG. 2B, the switch unit is an exemplary structure of an ink-type force sensing switch 1031. Of course, the structure of the ink-type force sensing switch 1031 may be varied according to the practical requirements.

As shown in FIG. 2B, the ink-type force sensing switch 1031 at least includes a top printed conductive film, a bottom printed conductive film and an elastic separation layer 10314. The elastic separation layer 10314 is arranged between the top printed conductive film and the bottom printed conductive film. The top printed conductive film at least includes a top substrate 10311, an upper conductive sliver paste layer 10312 and an upper carbonaceous conductive ink layer 10313. The bottom printed conductive film at least includes a lower carbonaceous ink layer 10315, a lower conductive silver paste layer 10316 and a bottom substrate 10317. In addition, an adhesive layer 10318 is arranged between the top substrate 10311 and the bottom substrate 10317.

Preferably, any of the top substrate 10311 and the bottom substrate 10317 is made of polyethylene terephthalate (PET), and the elastic separation layer 10314 is made of UV-curable adhesive.

Please refer to FIG. 1 again. As mentioned above, an electrical connection path is defined by the ink-type force sensing switch and the corresponding bias resistor 121 of the bias resistor circuit 12. When the ink-type force sensing switch is turned on, a divided conduction voltage (e.g., the voltage at the first terminal of the corresponding bias resistor 121 of the bias resistor circuit 12) is generated by the electrical connection path. According to the level of the divided conduction voltage, the controller 14 generates the corresponding key control instruction. For example, if the pressure-related resistance is higher than a resistance threshold value, the ink-type force sensing switch 1031 is in a light pressing mode. In the light pressing mode, the controller 30 generates a single key control instruction, for example a single key control instruction corresponding to the “A” key. Whereas, if the pressure-related resistance is lower than or equal to the resistance threshold value, the ink-type force sensing switch 1031 is in a heavy pressing mode. In the heavy pressing mode, the controller 14 generates a composite key control instruction, for example a composite key control instruction corresponding to the combination key “A”+“Shift”.

Furthermore, other operating modes may be selected can be selected by the controller 14 according to the divided conduction voltage (e.g., the voltage at the first terminal of the corresponding bias resistor 121 of the bias resistor circuit 12) generated by the electrical connection path. For example, the operation of a single key can achieve the function of quickly switching various input modes (e.g., Chinese/English/numeric input modes). Alternatively, the operation of the single key can achieve the function of quickly replacing different actions or characters in game programs. It is noted that the applications are not restricted.

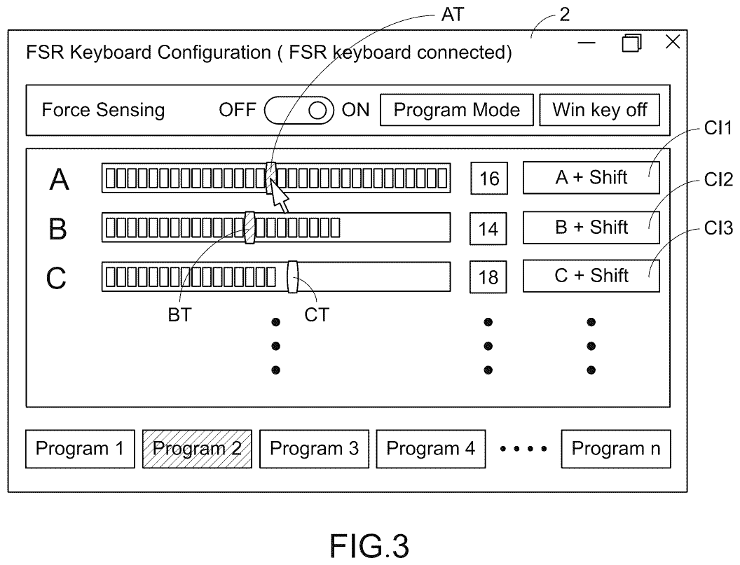

FIG. 3 schematically illustrates a process of defining the resistance threshold value of an ink-type force sensing switch 1031 in the switch unit of the composite function keyboard circuit as shown in FIG. 1 through an operation interface of an adjustment program. When the adjustment program is executed, the operation interface of the adjustment program is shown on a display screen.

For example, the adjustment program is an application software (APP). The resistance threshold value can be set by the user through the operation interface 2 of the adjustment program in a user-defined manner.

For example, in the operating environment of running the “Program 2” shown in FIG. 3, the resistance threshold values AT, BT and CT of the switch units corresponding to the three independent keys “A”, “B” and “C” can be adjusted by the user. By sliding the corresponding adjustment bars leftwards, the resistance threshold values are decreased. By sliding the corresponding adjustment bars rightwards, the resistance threshold values are increased. In other words, by sliding the adjustment bars in the operation interface 2, the resistance threshold values AT, BT and CT are adjusted according to the user's requirements. It is noted that the method of adjusting the resistance threshold value is not restricted.

For example, if the magnitude of the pressure-related resistance in response to the keypress action on the “A” key is higher than the resistance threshold value AT, the ink-type force sensing switch 1031 corresponding to the “A” key is in the light pressing mode. Meanwhile, the controller 14 generates a single key control instruction corresponding to the “A” key. Whereas, if the magnitude of the pressure-related resistance in response to the keypress action on the “A” key is lower than or equal to the resistance threshold value AT, the ink-type force sensing switch 1031 corresponding to the “A” key is in a heavy pressing mode. Meanwhile, the controller 14 generates a composite key control instruction CI1 corresponding to the combination key “A”+“Shift”.

Similarly, if the magnitude of the pressure-related resistance in response to the keypress action on the “B” key is higher than the resistance threshold value BT, the ink-type force sensing switch 1031 corresponding to the “B” key is in the light pressing mode. Meanwhile, the controller 14 generates a single key control instruction corresponding to the “B” key. Whereas, if the magnitude of the pressure-related resistance in response to the keypress action on the “B” key is lower than or equal to the resistance threshold value BT, the ink-type force sensing switch 1031 corresponding to the “B” key is in a heavy pressing mode. Meanwhile, the controller 14 generates a composite key control instruction CI2 corresponding to the combination key “B”+“Shift”.

Similarly, if the magnitude of the pressure-related resistance in response to the keypress action on the “C” key is higher than the resistance threshold value CT, the ink-type force sensing switch 1031 corresponding to the “C” key is in the light pressing mode. Meanwhile, the controller 14 generates a single key control instruction corresponding to the “C” key. Whereas, if the magnitude of the pressure-related resistance in response to the keypress action on the “C” key is lower than or equal to the resistance threshold value CT, the ink-type force sensing switch 1031 corresponding to the “C” key is in a heavy pressing mode. Meanwhile, the controller 14 generates a composite key control instruction CI3 corresponding to the combination key “C”+″Shift.

Please refer to FIG. 1 again. As mentioned above, the use of the composite function keyboard circuit 1 can achieve the purpose of operating a single key to execute various types of key function instructions. In accordance with another feature of the present invention, the use of the composite function keyboard circuit 1 can achieve the ghost key preventing function for the general key.

As mentioned above, the pressure-related resistance of the ink-type force sensing switch 1031 in response to the corresponding keypress action in the corresponding pressing mode. Furthermore, an electrical connection path is defined by the ink-type force sensing switch 1031, the anti-ghosting unit 1032 (e.g., a high-resistance element) and the corresponding bias resistor 121 of the bias resistor circuit 12.

If the ink-type force sensing switch 1031 of a specified switch unit 103 is not pressed down, the specified key switch 103 is turned off. If the ink-type force sensing switch 1031 of the specified ink-type force sensing switch 1031 is turned on, a divided conduction voltage from the ink-type force sensing switch 1031 can be obtained by the controller 14 through the additional electrical connection path according to a voltage divider rule. According to the divided conduction voltage, the controller 14 judges whether the ink-type force sensing switch 1031 of the specified switch unit 103 is effectively pressed down and turned on.

In an embodiment, the resistance of the anti-ghosting unit 1032 (e.g., a high-resistance element) and the resistance of the corresponding bias resistor 121 are equal or nearly equal (e.g., 5k ohms), and the lowest pressure-related resistance of the ink-type force sensing switch 1031 in response to the keypress action P is set to be in the range between 0 ohm and 300 ohms (i.e., approximately 0% and 6% of the resistance of the high-resistance carbon equivalent resistor). Consequently, according to a voltage divider rule, the divided conduction voltage in the electrical connection path is equal to or nearly equal to a half of the working voltage.

In an embodiment, the resistance of the anti-ghosting unit 1032 (e.g., a high-resistance element) and the resistance of the corresponding bias resistor 121 are equal or nearly equal (e.g., 5k ohms), and the highest pressure-related resistance of the ink-type force sensing switch 1031 in response to the keypress action P is set to be in the range between 1 k ohms and 2 k ohms (i.e., approximately 20% and 40% of the resistance of the high-resistance carbon equivalent resistor). According to a voltage divider rule, the divided conduction voltage in the electrical connection path is equal to or nearly equal to a half of the working voltage. Consequently, even if one switch unit is suffered from a ghost key phenomenon, the controller 14 can identify and judge the result correctly.

In addition, each of the bias resistors 121 of the bias resistor circuit 12 is connected with the corresponding sensing line 102 of the sensing line group. Consequently, the divided conduction voltage can be transmitted to the multiplexer 141 through the corresponding sensing line 102 of the sensing line group.

In an embodiment, the controller 14 provides a working voltage to the driving line group with a plurality of driving lines 101 sequentially and periodically. For example, the working voltage is a voltage for powering a general keyboard device in a normal working state.

Firstly, at a first time point, the controller 14 provides the working voltage to a driving line 101 of the driving line group. After the working voltage is provided to the driving line 101, the working voltage is provided to the plurality of switch units that are connected with the driving line 101. Then, each of the plurality of switch units connected with the driving line generate a corresponding divided conduction voltage to the corresponding sensing line 102 of the sensing line group. Then, at a second time point, the controller 14 provides the working voltage to a next driving line 101 of the driving line group. After the working voltage is provided to the next driving line 101, the working voltage is provided to the plurality of switch units that are connected with the next driving line 101. Then, each of the plurality of switch units connected with the next driving line generate a corresponding divided conduction voltage to the corresponding sensing line 102 of the sensing line group.

The above procedures are repeatedly done. Consequently, the switch units connected with the other driving lines 10 will successively generate the corresponding divided conduction voltages to the corresponding sensing lines 102 at different time points.

The divided conduction voltages from the plurality of sensing lines 102 are received by the multiplexer 141. These divided conduction voltages are successively transmitted from the multiplexer 141 to the analog-to-digital converter 142. Moreover, these divided conduction voltages are successively transmitted from the analog-to-digital converter 142 to the processor 143 in order to be judged by the processor 143.

The processor 143 judges whether the switch units 103 are normally turned on according to the divided conduction voltages from the corresponding sensing lines 102. For example, if the divided conduction voltage lies in a first voltage range, the processor 143 judges that the corresponding switch unit is normally turned on.

On the other hand, if the divided conduction voltage lies in a second voltage range, the processor 143 judges that the corresponding switch unit 103 is turned off. The second voltage range is lower than the first voltage range, but higher than zero. Moreover, if the divided conduction voltage lies in the second voltage range, the corresponding switch unit 103 is regarded as a ghost key. That is, even if the corresponding switch unit 103 generates the divided conduction voltage, the magnitude of the divided conduction voltage is not sufficient to turn on the switch unit. Under this circumstance, the processor 143 judges that the corresponding switch unit is not normally turned on.

In an embodiment, the first voltage range is from 0.228×Vi to 0.5×Vin, and the second voltage range is 0.06×Vin to 0.226×Vin, wherein Vin is the working voltage. In an embodiment, the working voltage is 5V. In other words, the first voltage range is from 1.14V to 2.5V, and the second voltage range is 0.32V to 1.13V.

If the divided conduction voltage is in the range between 1.14V and 2.5V, the processor 143 judges that the switch unit generating the divided voltage is normally turned on. Under this circumstance, the corresponding normal key signal or composite key signal is generated. Whereas, if the divided voltage is lower than 1.13V, the processor 303 judges that the switch unit generating the divided voltage is turned off and the switch unit is not triggered. Under this circumstance, no key signal will be generated.

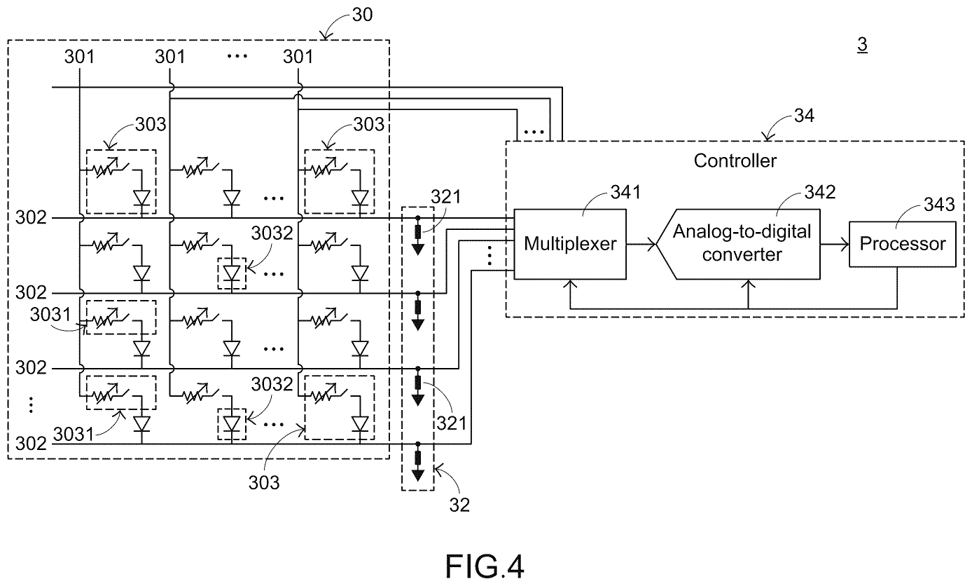

FIG. 4 is a schematic circuit diagram illustrating a composite function keyboard circuit according to a second embodiment of the present invention. As shown in FIG. 4, the composite function keyboard circuit 3 at least includes a matrix circuit 30, a bias resistor circuit 32 with a plurality of bias resistors 321, and a controller 34.

The matrix circuit 30 includes a driving line group with a plurality of driving lines 301, a sensing line group with a plurality of sensing lines 302 and a switch unit group with a plurality of switch units 303. The plurality of driving lines 301 are arranged along a vertical direction. The plurality of sensing lines 302 are arranged along a horizontal direction. The plurality of driving lines 301 and the plurality of sensing lines 302 are arranged in a matrix. Each of the switch units 303 is electrically connected with the corresponding one of the plurality of driving lines 301 and the corresponding one of the plurality of sensing lines 302.

In this embodiment, each of the switch units 303 includes an ink-type force sensing switch (FSR) 3031 and an anti-ghosting unit 3032.

The functions and operations of the bias resistor circuit 32 and the controller 34 in the composite function keyboard circuit 3 of FIG. 4 are similar to the functions and operations of the bias resistor circuit 12 and the controller 14 in the composite function keyboard circuit 1 of FIG. 1, and not redundantly described herein.

In comparison with FIG. 1, the anti-ghosting unit 3032 in the composite function keyboard circuit 3 of FIG. 4 is a diode. Since the current is allowed to flow in one direction through the arrangement of the diode, the ghost key phenomenon can be avoided.

In response to the keypress action on the ink-type force sensing switch 3031, a corresponding pressure-related resistance is generated. According to settings, the ratio of the pressure-related resistance to the resistance of the corresponding bias resistor in the electrical connection path is in a specified ratio range.

In an embodiment, the ratio of the pressure-related resistance to the resistance of the corresponding bias resistor in the electrical connection path is in the range between 0.6 and 1.6.

For example, the resistance of the bias resistor 321 is 500 ohms. Under this circumstance, the pressure-related resistance of the ink-type force sensing switch 3031 in response to the keypress action P is set to be in the range between 300 ohms (i.e., the lowest pressure-related resistance) and 800 ohms (i.e., the highest pressure-related resistance). That is, the pressure-related resistance is 0.6 to 1.6 times the resistance of the corresponding bias resistor 321. Consequently, the user can operate a single key to execute various types of key function instructions. Although the pressure-related resistance generated by the ink-type force sensing switch 3031 is in the range between 300 ohms and 800 ohms, the voltage level of the divided conduction voltage generated in the electrical connection path of the ink-type force sensing switch 3031, the anti-ghosting unit 3032 (i.e., the diode) and the corresponding bias resistor 321 is still subjected to the change. In other words, the function of operating a single key to execute various types of key function instructions and the function of avoiding the ghost key phenomenon can be both achieved.

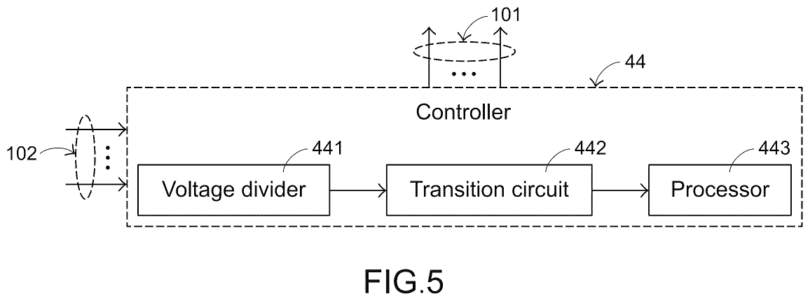

FIG. 5 is a schematic functional block diagram illustrating a variant example of the controller used in the composite function keyboard circuit of FIG. 1 according to the first embodiment of the present invention. As shown in FIG. 5, the controller 44 at least includes a voltage divider 441, a transition circuit 442 and a processor 443. The voltage divider 441 is electrically connected to with the sensing line group and the first terminals of the bias resistors 121 in the bias resistor circuit 12, which are shown in FIG. 1. The transition circuit 442 is electrically connected with the voltage divider 441. The processor 443 is electrically connected with the transition circuit 442 and the driving line group shown in FIG. 1. The transition circuit 442 at least includes a transistor such as a BJT transistor or a FET transistor.

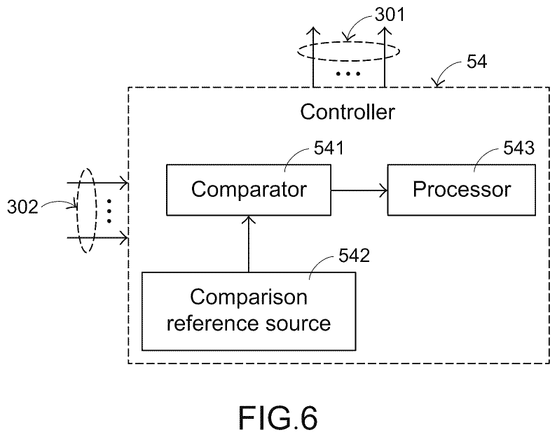

FIG. 6 is a schematic functional block diagram illustrating a variant example of the controller used in the composite function keyboard circuit of FIG. 4 according to the second embodiment of the present invention. As shown in FIG. 6, the controller 54 at least includes a comparator 541, a comparison reference source 542 and a processor 543. The comparator 541 is electrically connected with the sensing line group and the first terminals of the bias resistors 321 in the bias resistor circuit 32, which are shown in FIG. 4. The comparison reference source 542 is electrically connected with the comparator 541. The processor 543 is electrically connected with the comparator 541 and the driving line group shown in FIG. 4.

It is noted that the examples of the controllers 14 and 34 are not restricted. That is, numerous modifications and alterations may be made while retaining the teachings of the invention.

From the above descriptions, the present invention provides the composite function keyboard circuit. The composite function keyboard circuit is capable of operating a single key to execute various types of key function instructions while avoiding the ghost key phenomenon. In other words, the composite function keyboard circuit of the present invention are industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A composite function keyboard circuit, comprising:
a matrix circuit comprising a driving line group with a plurality of driving lines, a sensing line group with a plurality of sensing lines and a switch unit group with a plurality of switch units, wherein the plurality of driving lines and the plurality of sensing lines are arranged in a matrix, and each of the switch units of the switch unit group is electrically connected with the corresponding sensing line and the corresponding sensing line;
a bias resistor circuit electrically connected with the sensing line group and serially connected with the switch unit group, wherein the bias resistor circuit comprises a plurality of bias resistors, a first terminal of each bias resistor of the bias resistor circuit is electrically connected with the sensing line group and the switch unit group, and a second terminal of each bias resistor of the bias resistor circuit is connected with a ground terminal; and
a controller electrically connected with the driving line group, the sensing line group and the first terminal of each of the bias resistors of the bias resistor circuit,
wherein each of the switch units in the switch unit group includes an ink-type force sensing switch and an anti-ghosting unit, a pressure-related resistance of the ink-type force sensing switch is variable according to a pressing mode of a keypress action, and an electrical connection path is defined by the ink-type force sensing switch and the corresponding bias resistor of the bias resistor circuit,
wherein when the ink-type force sensing switch is electrically conducted, a divided conduction voltage is generated by the electrical connection path,
wherein according to a level of the divided conduction voltage, the controller generates a corresponding key control instruction, and the controller judges whether the switch unit in the switch unit group is effectively turned on, so that a ghost key phenomenon is avoided.

2. The composite function keyboard circuit according to claim 1, wherein a series electrical structure is defined by a first terminal of the ink-type force sensing switch and a first terminal of the anti-ghosting unit, wherein each driving line in the driving line group is electrically connected with one of a second terminal of the ink-type force sensing switch and a second terminal of the anti-ghosting unit in series, and each sensing line in the sensing line group is electrically connected with the other of the second terminal of the ink-type force sensing switch and the second terminal of the anti-ghosting unit in series.

3. The composite function keyboard circuit according to claim 1, wherein the anti-ghosting unit is a high-resistance element, and a resistance of the high-resistance element and a resistance of the corresponding bias resistor in the electrical connection path are equal or nearly equal.

4. The composite function keyboard circuit according to claim 3, wherein the high-resistance element is a high-resistance carbon equivalent resistor that is formed by using a carbon paste printing process.

5. The composite function keyboard circuit according to claim 3, wherein the pressure-related resistance of the ink-type force sensing switch in response to the keypress action is in a specified percentage range of the resistance of the high-resistance element.

6. The composite function keyboard circuit according to claim 5, wherein a highest value of the pressure-related resistance of the ink-type force sensing switch in response to the keypress action is in a range between 20% and 40% of the resistance of the high-resistance element.

7. The composite function keyboard circuit according to claim 5, wherein a lowest value of the pressure-related resistance of the ink-type force sensing switch in response to the keypress action is in a range between 0% and 6% of the resistance of the high-resistance element.

8. The composite function keyboard circuit according to claim 1, wherein the anti-ghosting unit is a diode, and a ratio of the pressure-related resistance of the ink-type force sensing switch in response to the keypress action to the resistance of the corresponding bias resistor in the electrical connection path is in a specified ratio range.

9. The composite function keyboard circuit according to claim 8, wherein the ratio of the pressure-related resistance to the resistance of the corresponding bias resistor in the electrical connection path is in a range between 0.6 and 1.6.

10. The composite function keyboard circuit according to claim 1, wherein as a force exerted on the ink-type force sensing switch in response to the keypress action is increased, the pressure-related resistance of the ink-type force sensing switch is decreased.

11. The composite function keyboard circuit according to claim 10, wherein if the pressure-related resistance is higher than a resistance threshold value, the ink-type force sensing switch is in a light pressing mode, and the controller generates a first key control instruction, wherein if the pressure-related resistance is lower than or equal to the resistance threshold value, the ink-type force sensing switch is in a heavy pressing mode, and the controller generates a second control instruction.

12. The composite function keyboard circuit according to claim 11, wherein the resistance threshold value is set by a user through an application software.

13. The composite function keyboard circuit according to claim 1, wherein the ink-type force sensing switch at least includes a top printed conductive film, a bottom printed conductive film and an elastic separation layer, wherein the elastic separation layer is arranged between the top printed conductive film and the bottom printed conductive film.

14. The composite function keyboard circuit according to claim 13, wherein the top printed conductive film at least includes a top substrate, an upper conductive sliver paste layer and an upper carbonaceous conductive ink layer, and the bottom printed conductive film at least includes a lower carbonaceous ink layer, a lower conductive silver paste layer and a bottom substrate, wherein an adhesive layer is arranged between the top substrate and the bottom substrate.

15. The composite function keyboard circuit according to claim 14, wherein each of the top substrate and the bottom substrate is made of polyethylene terephthalate (PET), or the elastic separation layer is made of UV-curable adhesive.

16. The composite function keyboard circuit according to claim 1, wherein at a first time point, the controller provides a working voltage to a first one of the plurality of driving lines in the driving line group, and the divided conduction voltages from the switch units connected with the first one of the plurality of driving lines are transmitted through the sensing line group, wherein at a second time point, the controller provides the working voltage to a second one of the plurality of driving lines in the driving line group, and the divided voltages from the switch units connected with the second one of the plurality of driving lines are transmitted through the sensing line group.

17. The composite function keyboard circuit according to claim 16, wherein if the divided conduction voltage corresponding to a specified switch unit of the plurality of switch units lies in a first voltage range, the controller judges that the specified switch unit is normally turned on, wherein if the divided conduction voltage corresponding to the specified switch unit lies in a second voltage range, the controller judges that the specified switch unit is not normally turned on.

18. The composite function keyboard circuit according to claim 17, wherein the working voltage is Vin, and the first voltage range is from 0.228×Vi to 0.5×Vin.

19. The composite function keyboard circuit according to claim 17, wherein the working voltage is Vin, and the second voltage range is 0.06×Vin to 0.226×Vin.

20. The composite function keyboard circuit according to claim 17, wherein the working voltage is 5V.

21. The composite function keyboard circuit according to claim 20, wherein the first voltage range is from 1.14V to 2.5V.

22. The composite function keyboard circuit according to claim 20, wherein the second voltage range is 0.32V to 1.13V.

23. The composite function keyboard circuit according to claim 1, wherein the controller includes a multiplexer, an analog-to-digital converter and a processor, wherein the multiplexer is electrically connected with the sensing line group and the first terminal of each of the plurality of bias resistors in the bias resistor circuit, the analog-to-digital is electrically connected with the multiplexer, and the processor is electrically connected with the multiplexer, the analog-to-digital converter and the driving line group.

24. The composite function keyboard circuit according to claim 1, wherein the controller at least comprises a voltage divider, a transition circuit and a processor, wherein the voltage divider is electrically connected to with the sensing line group and the first terminal of each of the plurality of bias resistors in the bias resistor circuit, the transition circuit is electrically connected with the voltage divider, and the processor is electrically connected with the transition circuit and the driving line group, wherein the transition circuit at least comprises a transistor.

25. The composite function keyboard circuit according to claim 1, wherein the controller at least comprises a comparator, a comparison reference source and a processor, wherein the comparator is electrically connected with the sensing line group and the first terminal of each of the plurality of bias resistors in the bias resistor circuit, the comparison reference source is electrically connected with the comparator, and the processor is electrically connected with the comparator and the driving line group.
